(19) United States
(12) Patent Application Publication
(10) Pub. No.: US 2024/0155404 A1
(43) Pub. Date: May 9, 2024

(54) METHOD AND APPARATUS OF QOE REPORTING FOR XR MEDIA SERVICES

(71) Applicant: Samsung Electronics Co., Ltd., Suwon-si (KR)

(72) Inventors: Eric YIP, Suwon-si (KR); Jaeyeon SONG, Suwon-si (KR)

(21) Appl. No.: 18/501,917

(22) Filed: Nov. 3, 2023

(30) Foreign Application Priority Data
Nov. 7, 2022 (KR) 10-2022-0147144

(51) Int. Cl. H04W 24/10

(52) U.S. Cl. CPC H04W 24/10

(57) ABSTRACT

The disclosure relates to a 5G or 6G communication system for supporting a higher data transmission rate. A method of a user equipment (UE) performing a quality of experience (QoE) reporting operation for extended reality (XR) media services is disclosed. The method comprises receiving configuration information for a QoE reporting operation, determining whether an event for the QoE reporting operation is triggered based on the configuration information, generating a frame rate QoE metric comprising pose information of the UE, generating a round-trip time (RTT) QoE metric comprising a tethered delay between at least one tethered device and the UE, generating a codec QoE metric comprising 3D media codec type for 3D media, in response to the event being triggered, generating a QoE report comprising at least one of the frame rate QoE metric, the RTT QoE metric, or the codec QoE metric, and transmitting the generated QoE report.

### CROSS-REFERENCE TO RELATED APPLICATION

This application is based on and claims priority under 35 U.S.C. § 119 to Korean Patent Application No. 10-2022-0147144, which was filed in the Korean Intellectual Property Office on Nov. 7, 2022, the entire disclosure of which is incorporated herein by reference.

### BACKGROUND

### 1. Field

The disclosure relates to a method and apparatus of quality of experience (QoE) reporting for extended reality (XR) media services.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in tera-hertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

3GPP standard specification TS 26.114 defines multimedia telephony services (MTSI) QoE metrics, allowing MTSI clients in a terminal (e.g., a user equipment (UE)) to be able to report about the MTSI session for the conversational service, using the defined metrics for video, speech, and text.

The above information is presented as background information only to assist with an understanding of the disclosure. No determination has been made, and no assertion is made, as to whether any of the above might be applicable as prior art with regard to the disclosure.

### SUMMARY

This disclosure introduces several extensions to the QoE reporting mechanism for real-time media MTSI services.

This disclosure may relate to media specific metric definitions to support XRM, pose, haptics, 3D media and/or audio.

This disclosure may relate to new configuration and rules for XRM.

This disclosure may relate to additional location filters for QoE reporting defined through location characteristics of the XR service.

This disclosure may relate to a fifth generation (5G) network systems for multimedia, quality of service (QoS), policy control enhancements supporting multi-modal, tethered devices and scenarios for haptic and/or XR, QoE enhancements for XR media (XRN) for real-time multimedia services over internet protocol (IP) multimedia subsystem (IMS).

This disclosure may relate to a support of QoE mechanisms to support haptic and XR related interactive based reporting including for pose information, haptic information, three-dimensional (3D) media, and/or audio.

In accordance with an embodiment of the disclosure, a method of a user equipment (UE) performing a quality of experience (QoE) reporting operation for extended reality (XR) media services is disclosed. The method may comprise receiving configuration information for a QoE reporting operation, determining whether an event for the QoE reporting operation is triggered based on the configuration information, generating a frame rate QoE metric comprising pose information of the UE, generating a round-trip time (RTT) QoE metric comprising a tethered delay between at least one tethered device and the UE, generating a codec QoE metric comprising 3D media codec type for 3D media, in response to the event being triggered, generating a QoE report comprising at least one of the frame rate QoE metric, the RTT QoE metric, or the codec QoE metric, and transmitting the generated QoE report.

In accordance with an embodiment of the disclosure, an apparatus of a user equipment (UE) performing a quality of experience (QoE) reporting operation for extended reality (XR) media services is disclosed. The apparatus may comprise a transceiver, and a processor coupled with the transceiver. The processor is configured to receive configuration information for a QoE reporting operation, determine whether an event for the QoE reporting operation is triggered based on the configuration information, generate a frame rate QoE metric comprising pose information of the UE, generate a round-trip time (RTT) QoE metric comprising a tethered delay between at least one tethered device and the UE, generate a codec QoE metric comprising 3D media codec type for 3D media, in response to the event being triggered, generate a QoE report comprising at least one of the frame rate QoE metric, the RTT QoE metric, or the codec QoE metric, and transmit the generated QoE report.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a 3G network according to embodiments of the present disclosure.

FIG. 2 illustrates a structure of a LTE network according to embodiments of the present disclosure.

FIG. 3 illustrates a structure of a voice and video codec of a voice over LTE according to embodiments of the present disclosure.

FIG. 4 illustrates a situation in which media from, and to a mobile phone UE is transmitted using a 5G network according to embodiments of the present disclosure.

FIG. 5 illustrates a procedure for a transmitting terminal and a receiving terminal to negotiate a transmission method of a conversational service using IMS according to embodiments of the present disclosure.

FIG. 6 illustrates a procedure of a receiving terminal for establishing an SDP answer from an SDP offer transmitted by the transmitting terminal according to embodiments of the present disclosure.

FIG. 7 illustrates a UE according to embodiments of the present disclosure.

FIG. 8 illustrates a flow chart of UE for reporting QoE according to embodiments of the present disclosure.

FIG. 9 illustrates a management object tree for QoE reporting according to embodiments of the present disclosure.

FIG. 10 illustrates a management object tree of QoE metrics according to an embodiment of the present disclosure.

### DETAILED DESCRIPTION

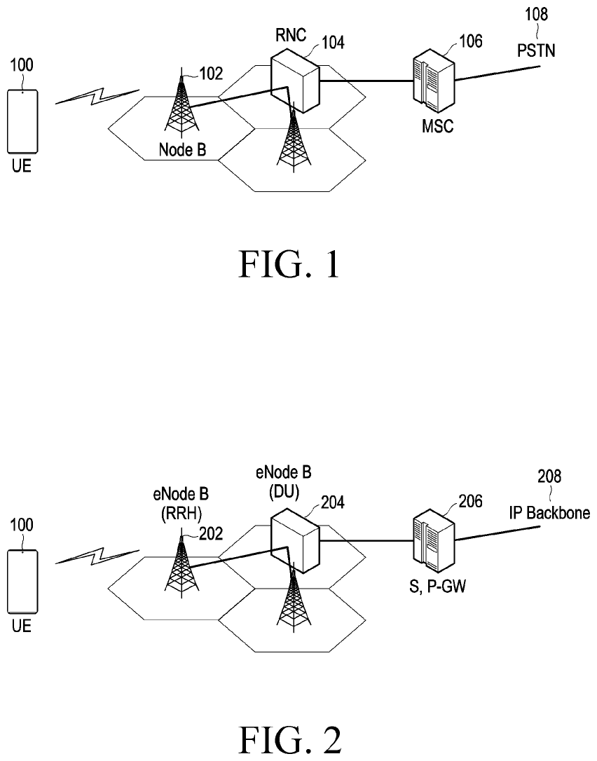

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component” includes reference to one or more of such components.

The disclosure may relate to multimedia content processing authoring, pre-processing, post-processing, metadata delivery, delivery, decoding and rendering of, virtual reality, mixed reality and augmented reality contents, including two-dimensional (2D) video, 360 video, three-dimensional (3D) media represented by point clouds and meshes. The disclosure may also relate to virtual reality (VR) devices, eXtended Reality (XR) devices, session description protocol (SDP) negotiation. The disclosure may also relate to support of immersive teleconferencing and telepresence for remote terminals. The disclosure may also relate to conversational 360 video VR capture, processing, rendering, fetching, delivery, rendering.

FIG. 1 illustrates a structure of a 3G network consisting of a user equipment (UE) 100, a base station (e.g., NodeB (NB)) 102, a radio network controller (RNC) 104, and a mobile switching center (MSC) 106.

Referring to FIG. 1, the 3G network may be connected to another mobile communication network (e.g., a public switched telephone network (PSTN) 108). In such the 3G network, voice may be compressed and restored with an adaptive multi-rate (AMR) codec. The AMR codec may be installed in a terminal (e.g., the UE 100) and the MSC 106 to provide a two-way call service. The MSC 106 may convert the voice compressed in the AMR codec into a PCM (pulse-code modulation) format and transmits the voice in the PCM format to the PSTN 108. The MSC 106 may transmit the voice in the PCM format from the PSTN 108, compress the voice in the PCM format into the AMR codec, and transmit the voice compressed in the AMR codec to the base station 102. The RNC 104 may control the call bit rate of the voice codec installed in the UE 100 and the MSC 106 in real time using the codec mode control (CMC) messages.

FIG. 2 illustrates a structure of a long term evolution (LTE) network consisting of a UE 100, a base station 202/204 (e.g., enhanced NodeB (eNB)), and at least one gateway 206 (e.g., serving gateway (S-GW), and/or packet gateway (P-GW)).

Referring to FIG. 2, In a packet-switched network introduced in 4G, the voice codec is installed only in the terminal (e.g., the UE 100), and the voice frame compressed at intervals of 20 ms (millisecond) may be not restored at the base station (e.g., the Node B 202 and 204) or the network node (e.g., the at least one gateway 206) located in the middle of the transmission path and is transmitted to the counterpart terminal (not shown).

The voice codec may be installed only in the UE 100, and the UE 100 may adjust the voice bit rate of the counterpart terminal (not shown) using a codec mode request (CMR) message.

The eNodeB, which is a base station, may be divided into a remote radio head (RRH) 202 dedicated to RF (radio frequency) functions and a digital unit (DU) 204 dedicated to modem digital signal processing. The eNodeB 202/204 may be connected to the IP backbone network 208 through the S-GW and the P-GW. The IP backbone network 208 may be connected to the mobile communication network (not shown) and/or Internet of other service providers (not shown).

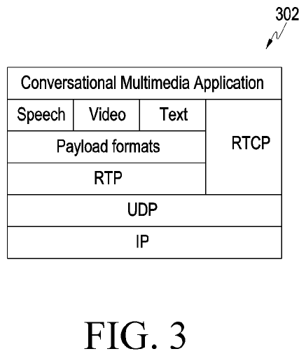

FIG. 3 illustrates a structure of a voice and video codec of a voice over LTE (VoLTE) supported terminal (e.g., the UE 100) and a real time transport protocol (RTP)/user datagram protocol (UDP)/IP protocol.

Referring to FIG. 3, the IP protocol located at the bottom of this structure 302 may be connected to the packet data convergence protocol (PDCP) located at the top of the protocol structure 302. The RTP/UDP/IP header may be attached to the compressed media frame in the voice and video codec and transmitted to the counterpart terminal through the LTE network. In addition, the counterpart terminal may receive the media packet compressed and transmitted from the network (e.g., the LTE network), restores the media, listens to the speaker and the display, and views the media. At this time, even if the compressed voice and video packet do not arrive at the same time, the Timestamp information of the RTP protocol header may be used to synchronize the two media to listen and watch.

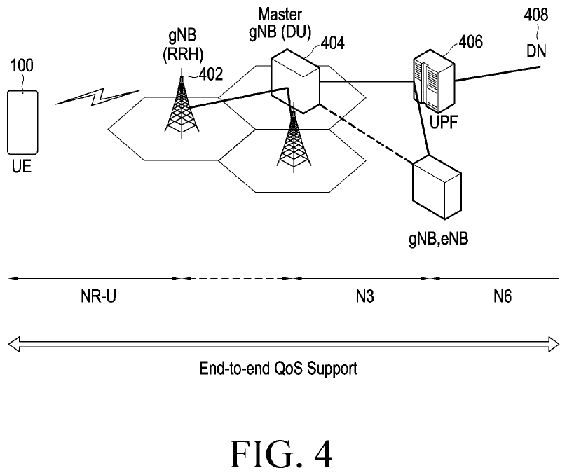

FIG. 4 illustrates a situation in which media from, and to a mobile phone UE is transmitted using a 5G network consisting of a UE 100, a base station 402/404 (e.g., 5G Node B (gNB)), a user plane function (UPF) 406, and data network (DN) 408.

Referring to FIG. 4, the eNodeB 202/204, S-GW, and P-GW of LTE may correspond to gNB 402/404, UPF 406, and the DN 408 in the 5G network. In this case, conversational media, including video and audio, may be transmitted using the 5G network. Related to embodiments of this disclosure, additionally data related to QoE reporting may also be transmitted using the 5G network.

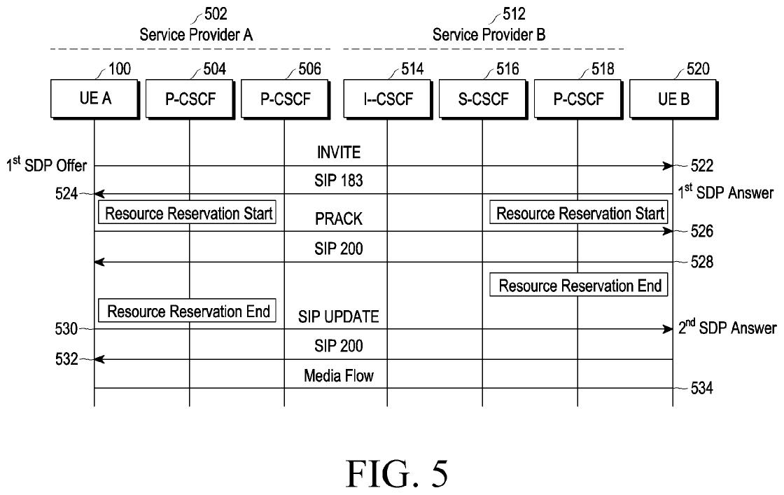

FIG. 5 illustrates a procedure for a transmitting terminal (e.g., a UE A 100) and a receiving terminal (e.g., a UE B 520) to negotiate a transmission method of a conversational service using the IP multimedia subsystem (IMS). The IMS may be shown in FIG. 4. FIG. 5 may illustrate an exemplary procedure for the UE A 100 and the UE B 520) to secure the QoS of a wired and wireless transmission path.

Referring to FIG. 5, the transmitting terminal 100 may transmit the session description protocol (SDP) request message (e.g., SDP Offer) 522 to the proxy call session control function (P-CSCF) 504 in the service provider A 502, which has an IMS node allocated to the transmitting terminal 100, in the session initiation protocol (SIP) invite message 524. This message 524 may be transmitted to the IMS connected to the counterpart terminal 520 through nodes such as a session call session control function (S-CSCF) 506 the service provider A 502, interrogating call session control function (I-CSCF) 514, S-CSCF 516, and P-CSCF 518 in the service provider B 512, and finally to the receiving terminal 520.

The receiving terminal 520 may select an acceptable bit rate and a transmission method from among the bit rates provided by the transmitting terminal 100. For a conversational service, the receiving terminal 520 may also select a desired configuration according to that offered by the transmitting terminal 100, including these information in an SDP answer message in the SIP 183 message 524 in order to transmit the SDP answer message to the transmitting terminal 100. In this case, the transmitting terminal 100 may be a multimedia resource function (MRF) instead of a UE device. The MRF may be a network entity and may exist between the transmitting terminal 100 and the receiving terminal 520 in the IMS. The MRF may intermediate the transmitting terminal 100 and the receiving terminal 520.

In the process of transmitting this message 524 to the transmitting terminal 100, each IMS node starts to reserve transmission resources of the wired and/or wireless networks required for this service, and all the conditions of the session are agreed through additional procedures (526, 528 and/or 530, 532). A transmitting terminal 100 that confirms that transmission resources of all transmission sections may be secured and may transmit media flow 534 (e.g., image videos) to the receiving terminal 520.

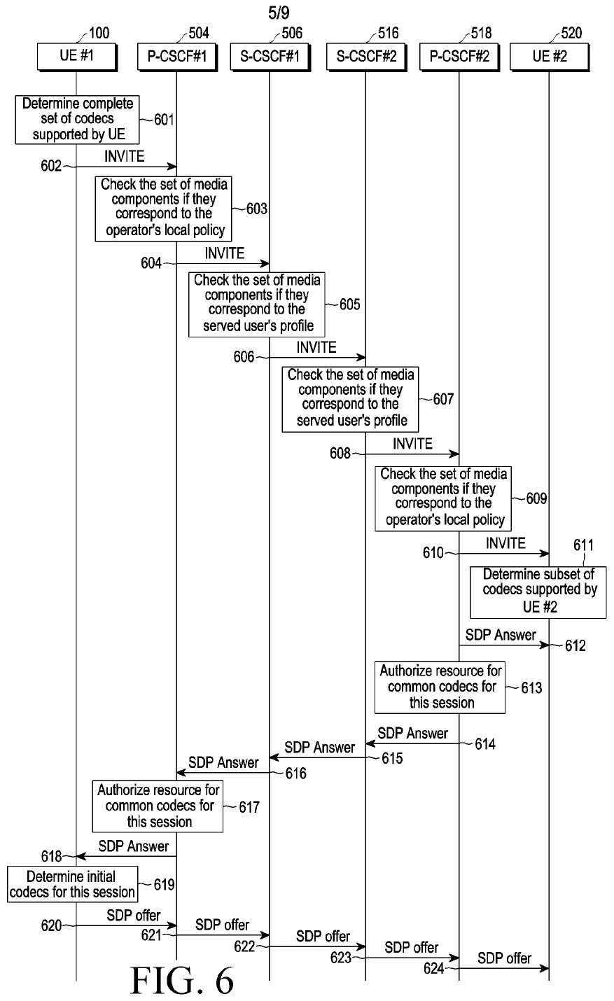

FIG. 6 illustrates a procedure of a receiving terminal for establishing an SDP answer from an SDP offer transmitted by the transmitting terminal according to embodiments of the present disclosure.

Referring to FIG. 6, the detailed procedure may be as follows:

At operation 601, a UE #1 (e.g., the transmitting terminal or the UE A 100) may insert a codec(s) to an SDP payload. The inserted codec(s) may reflect the UE #1's terminal capabilities and user preferences for the session capable of supporting for this session. UE #1 100 may build an SDP containing media parameters (e.g., bandwidth requirements and/or characteristics of each), and may assign local port numbers for each possible media flow. Multiple media flows may be offered, and for each media flow (e.g., “m=” line in SDP), there may be multiple codec choices offered.

At operation 602, the UE #1 100 may send the initial INVITE message to P-CSCF #1 504 containing this SDP.

At operation 603, P-CSCF #1 504 may examine the media parameters. If P-CSCF #1 504 finds media parameters not allowed to be used within an IMS session (based on P-CSCF local policies, or if available bandwidth authorization limitation information coming from the policy and charging rules function (PCRF)/policy control function (PCF), P-CSCF #1 504 may reject the session initiation attempt. This rejection may contain sufficient information for the originating UE (e.g., the UE #1 100) to re-attempt session initiation with media parameters that are allowed by local policy of P-CSCF #1's network. (e.g., according to the procedures specified in internet engineering task force (IETF) RFC 3261). In this flow described in FIG. 6 above the P-CSCF #1 504 may allow the initial session initiation attempt to continue. Whether the P-CSCF #1 504 interacts with PCRF/PCF in the operation 603 may be based on operator policy.

At operation 604, P-CSCF #1 504 may forward the INVITE message to 5-CSCF #1 506.

AT operation 605, S-CSCF #1 506 may examine the media parameters. If 5-CSCF #1 506 finds media parameters that local policy or the originating user's subscriber profile does not allow to be used within an IMS session, S-CSCF #1 506 may reject the session initiation attempt. This rejection may contain sufficient information for the originating UE (e.g., UE #1 100) to re-attempt session initiation with media parameters that are allowed by the originating user's subscriber profile and by local policy of S-CSCF #1's network. (e.g., according to the procedures specified in IETF RFC 3261). In this flow described in FIG. 6 above the S-CSCF #1 506 may allow the initial session initiation attempt to continue.

At operation 606, S-CSCF #1 506 may forward the INVITE, through a S-S Session Flow Procedures, to S-CSCF #2 516. The S-S session flow procedures may be an invite sequence information flow procedure between the S-CSCF #1 506 and S-CSCF #2 516.

At operation 607, S-CSCF #2 516 may examine the media parameters. If 5-CSCF #2 516 finds media parameters that local policy or the terminating user's subscriber profile does not allow to be used within an IMS session, S-CSCF #2 516 may reject the session initiation attempt. This rejection may contain sufficient information for the originating UE 100 to re-attempt session initiation with media parameters that are allowed by the terminating user's subscriber profile and by local policy of S-CSCF #2's network. (e.g., according to the procedures specified in IETF RFC 3261). In this flow described in FIG. 6 above the S-CSCF #2 51 may allow the initial session initiation attempt to continue.

At operation 608, S-CSCF #2 516 may forward the INVITE message to P-CSCF #2 518.

At operation 609, P-CSCF #2 518 may examine the media parameters. If P-CSCF #2 518 finds media parameters not allowed to be used within an IMS session (based on P-CSCF local policies, or if available bandwidth authorization limitation information coming from the PCRF/PCF), P-CSCF #2 518 may reject the session initiation attempt. This rejection may contain sufficient information for the originating UE 100 to re-attempt session initiation with media parameters that are allowed by local policy of P-CSCF #2's network. (e.g., according to the procedures specified in IETF RFC 3261). In this flow described in FIG. 6, the P-CSCF #2 518 may allow the initial session initiation attempt to continue. Whether the P-CSCF #2 518 interacts with PCRF/PCF in this operation 609 may be based on operator policy.

At operation 610, P-CSCF #2 518 may forward the INVITE message to UE #2 520.

At operation 611, a UE #2 520 may determine the complete set of codecs capable of supporting for this session. The UE #2 520 may determine the intersection with those appearing in the SDP in the INVITE message. For each media flow that is not supported, the UE #2 520 may insert an SDP entry for media (‘m=’ line) with port=0. For each media flow that is supported, UE #2 520 may insert an SDP entry with an assigned port and with the codecs in common with those in the SDP from UE #1 100.

At operation 612, the UE #2 520 may return the SDP response (e.g., SDP Answer) listing common media flows and codecs to P-CSCF #2 518.

At operation 613, P-CSCF #2 518 may authorize QoS resources for the remaining media flows and codec choices.

At operation 614, P-CSCF #2 518 may forward the SDP response to S-CSCF #2 516.

At operation 615, S-CSCF #2 516 forwards the SDP response to S-CSCF #1 506.

At operation 616, S-CSCF #1 506 may forward the SDP response to P-CSCF #1 504.

At operation 617, P-CSCF #1 504 may authorize the QoS resources for the remaining media flows and codec choices.

At operation 618, P-CSCF #1 504 may forward the SDP response to UE #1 100.

At operation 619, UE #1 100 may determine which media flows may be used for this session, and which codecs may be used for each of those media flows. If there was more than one media flow, or if there was more than one choice of codec for a media flow, then the UE #1 100 need to renegotiate the codecs by sending another offer to reduce codec to one with the UE #2 520 (e.g., select one codec and remain the selected codec in another offer message to renegotiate).

At operations 620, 621, 622, 623, and 624, the UE #1 100 may send the “SDP Offer” message to the UE #2 520, along the signalling path established by the INVITE request.

The remainder of the multi-media session may complete identically to a single media/single codec session if the negotiation results in a single codec per media.

In embodiments of the present disclosure, the UE (e.g., 100) may include MTSI client, and report one or more QoE metrics to a server supporting OMA-DM (open mobile alliance—device management). The server (e.g., an OMA-DM configuration server) may configure activation/deactivation of QoE metrics and gathering of QoE metrics in the UE.

In embodiments of the present disclosure, the UE may receive a QoE configuration of QoE reporting from a network entity (e.g., the OMA-DM configuration server). The UE supporting the QoE metrics may perform quality measurements in accordance with measurement definitions, aggregate quality measurements into QoE metrics and report the QoE metrics to the server (e.g., the OMA-DM configuration server). The UE may send QoE report including QoE metrics during a session (e.g., the MTSI session or a reporting session) and at the end of the session.

In embodiments of the present disclosure, the QoE configuration may be evaluated by the UE at the start of a QoE measurement and a reporting session (e.g., a QoE session) associated with a MTSI session. The UE may perform evaluation of at least one filtering criteria such as by geographical area.

In embodiments of the present disclosure, when a session (e.g., the MTSI session) is started, the UE may determine whether QoE reporting is required for the session based on the QoE configuration. If the QoE reporting is enabled, the UE may check the QoE reporting rule of the QoE configuration.

If the QoE reporting is needed, the UE may continuously compute specified metrics for each measurement interval period, according to a measure-resolution of the QoE reporting rule. The UE may send QoE report messages to the server in accordance with a reporting interval, (e.g., a sending-rate) of the QoE reporting rule. The QoE metrics stored in the UE may be sent to the server.

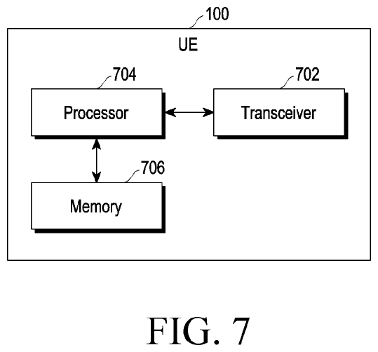

FIG. 7 illustrates a UE according to embodiments of the present disclosure.

Referring to FIG. 7, the UE (e.g., the UE 100) may comprise a transceiver 702, a processor 704 (e.g., a controller), and a memory 706. The transceiver 702 may comprise a communication circuitry for radio communications, to be configured for transmitting/receiving messages or signals from/to at least one network entity (e.g., a base station 102/202/402). The transceiver 702 may comprise a transmitter and a receiver. The processor 704 may be configured to control at least one component (e.g., the transceiver 702) of the UE 100 to perform operations according to embodiments in the disclosure. The memory 706 is configured to store data or control information according to embodiments in the disclosure.

In one embodiment, the processor 704 may comprise one or more components supporting an MTSI session, e.g., an audio decoder, a video decoder, an audio encoder, a video encoder, a text processing module, a data channel processing module, a session setup and control module, or a packet-based network interface module. In one embodiment, the UE 100 may comprise one or more components supporting the MTSI session, e.g., a speaker, a display, a user interface, a microphone, a camera, or a keyboard.

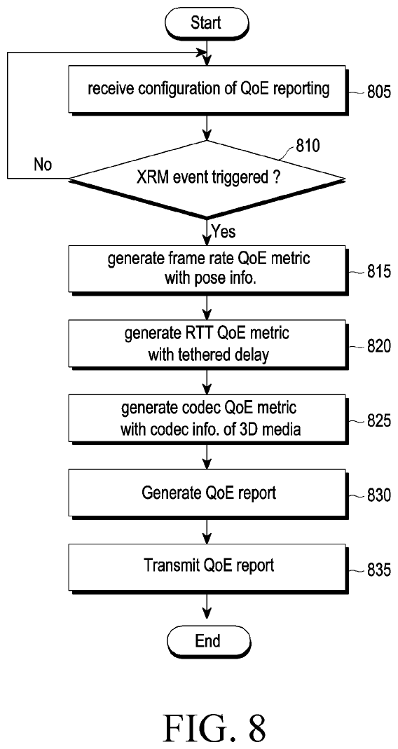

FIG. 8 illustrates a flow chart of UE for reporting QoE (e.g., the UE 100) according to embodiments of the present disclosure. At least one of the operations described below may be executed by the processor 704 of the UE 100.

Referring to FIG. 8, at operation 805, the UE 100 may receive configuration information of QoE reporting from a server (e.g., the OMA-DM configuration server). In one embodiment, the configuration information (e.g., QoE configuration) may comprise at least one of a configuration of QoE metrics, a QoE metrics activation, or a QoE reporting rule. At operation 810, the UE 100 may decide whether XRM event is triggered based on the configuration information (e.g., the QoE reporting rule). If the XRM event is triggered, the UE 100 may perform at least one of operations 815, 820, and 825.

At operation 815, the UE 100 may generate a frame rate QoE metric comprising pose information (e.g., a location and/or an orientation) of the UE 100. At operation 820, the UE 100 may generate a round-trip time (RTT) QoE metric comprising a tethered delay between at least one tethered device (e.g., a wearable device) and the UE. At operation 825, the UE 100 may generate a codec QoE metric comprising codec information (e.g., description information of 3D media codec type) for 3D media.

At operation 830, the UE may generate a QoE report comprising at least one of the frame rate QoE metric, the RTT QoE metric, or the codec QoE metric. At operation 835, the UE may transmit the generated QoE report to a server (e.g., the OMA-DM configuration server). In one embodiment, the QoE report may be transmitted according to the QoE reporting rule.

There are two mechanisms for QoE reporting for the UE 100 (e.g., a MTSI client).

In one embodiment, the UE 100 which supports QoE reporting may support OMA-DM, where the OMA-DM configuration server may configure activation, deactivation, and the gathering of QoE metrics.

In an alternative embodiment, QoE configuration may be done using QMC (QoE measurement collection) functionality as defined in the standard (e.g., 3GPP standard specification TS 26.114).

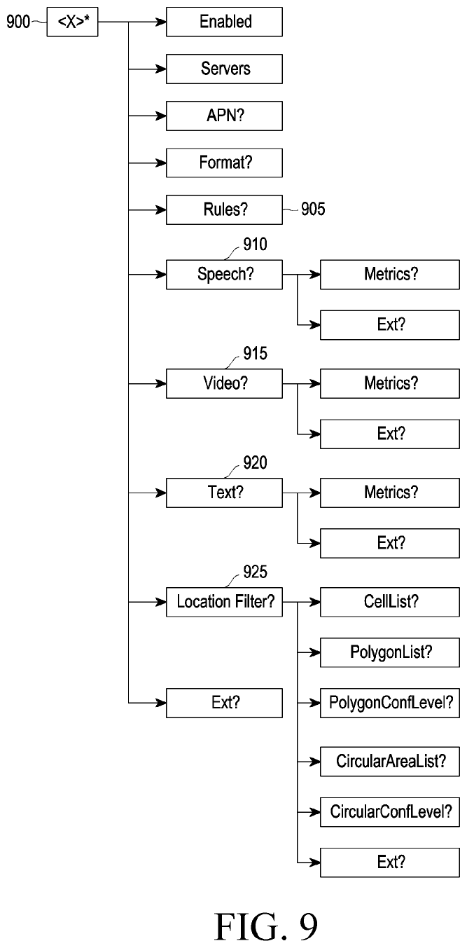

FIG. 9 illustrates a management object tree for QoE reporting when QoE is configured via OMA-DM, known as the 3GPP MTSI QoE metrics management object tree. In one embodiment, the nodes and leaves of the object tree 900 may contain media specific metric definitions, including at least one of speech node 910, video node 915, text node 920, rules node 905, or a location filter node 925.

There may be many extensions to the MTSI conversational services for more immersive media (such as the ITT4RT (Immersive Teleconferencing and Telepresence for Remote Terminals) extensions for 360 video conferencing) as well as multiple QoS/policy control enhancements to the 5GS (5G system) (done by the SA2 working group) for supporting multi-modal, as well as tethered device scenarios for haptic and XR. Mechanisms may be required to support haptic and/or XR related interactive based reporting in MTSI services (e.g., real-time services).

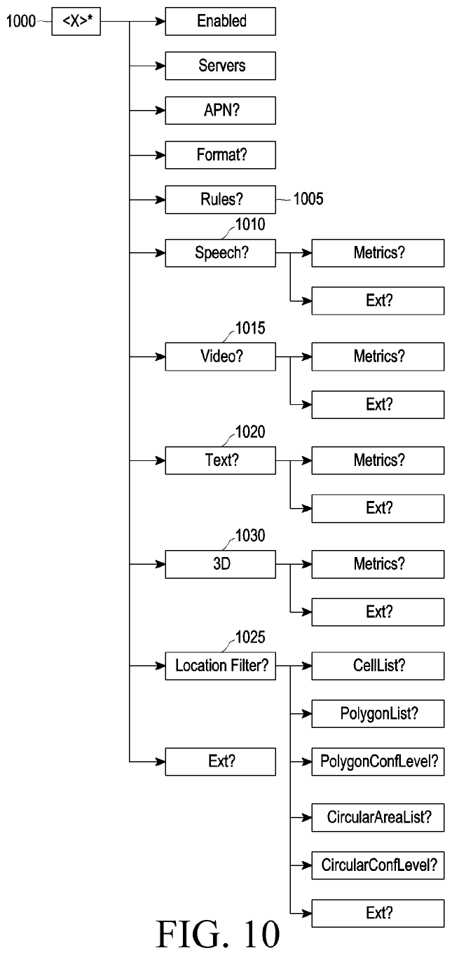

FIG. 10 illustrates a management object tree of QoE metrics according to an embodiment of the present disclosure.

Referring to FIG. 10, the nodes and leaves of the object tree 1000 may contain at least one of speech node 1010, video node 1015, text node 1020, rules node 1005, or a location filter node 1025 similar to the nodes of FIG. 9. In one embodiment, the management object tree 1000 may comprise a 3D node 1030 for 3D media (e.g., polygons, or point clouds), and corresponding leaf/node (1030a, 1030b) for metrics and extension.

Table 1 shows an example of the 3D node 1030 and the leaves (e.g., 3D/metrics 1030a and or 3D/Ext 1030b) according to an embodiment of the present disclosure.

```
TABLE 1
/<X>/3D
The 3D node is the starting point of the 3D media level QoE metrics
definitions.
  - Occurrence: ZeroOrOne
  - Format: node
  - Minimum Access Types: Get
/<X>/3D/Metrics
This leaf provides in textual format the QoE metrics that need to be
reported, the measurement frequency, the reporting interval and the
reporting range. The syntax and semantics of this leaf are defined in
clause 16.3.2.
  - Occurrence: ZeroOrOne
  - Format: chr
  - Access Types: Get
  - Values: see clause 16.3.2.
/<X>/3D/Ext
The Ext is an interior node where the vendor specific information can be
placed (vendor meaning application vendor, device vendor etc.). Usually
the vendor extension is identified by vendor specific name under the Ext
node. The tree structure under the vendor identified is not defined and
can therefore include one or more un-standardized sub-trees.
  - Occurrence: ZeroOrOne
  - Format: node
  - Minimum Access Types: Get
```

In embodiments of the present disclosure, one or more nodes for pose information (location, orientation), and/or haptic information are also included as part of the management object tree 1000. In one embodiment, at least one the frame rate QoE metric, the RTT QoE metric, or the codec QoE metric is included in the 3D node 1030 or other node (e.g., the speech node 1010, the video node 1015, the location filter node 1025, or extension node). Existing definitions for the metrics of the nodes 1010, 1015, and 1025) may be found under clause 16.2 of TS 26.114.

Embodiments of the present disclosure may define the frame rate QoE metric to include the pose information (e.g., pose frequency) The frame rate QoE metric may be used to report pose information related QoE details, when included in a QoE report from the UE 100.

For the pose information, the frame rate QoE metric may indicate the pose frequency of the pose information which is measured and utilized by the UE 100. The pose frequency may be expressed in number of pose instances (e.g., a location and/or an orientation of the UE) per second.

Table 2 shows an example of the frame rate QoE metric according to an embodiment of the present disclosure.

TABLE 2
16.2.3 Frame rate
Frame rate indicates the playback frame rate. The playback frame rate is
equal to the number of frames displayed during the measurement
resolution period divided by the time duration, in seconds, of the
measurement resolution period.
For pose information, this metric indicates the frequency of the pose
information which is measured and utilized by the UE, expressed in
number of pose instances per second.
The syntax for the metric “Frame_Rate” is defined in sub-clause 16.3.2.
For the Metrics-Name “Frame_Rate”, the value field indicates the frame
rate value. This metric is expressed in frames per second, and can be a
fractional value. The frame rates for each resolution period are stored in
the vector FrameRate and reported by the MTSI client as part of the QoE
report (sub-clause 16.4).

Embodiments of the present disclosure may define the round-trip time (RTT) QoE metric to include at least one tethered device (e.g., a wearable device) connected to the UE 100 The RTT QoE metric may be used to report QoE details related to the tethered device, when included in a QoE report from the UE 100.

For an XRM application which is executing in the UE 100, the UE 100 may measure the RTT including an additional tethered delay due to the tethered connection latency between one or more tethered devices and the UE 100 (e.g., the tethered delay from the tethered device to the UE). In one embodiment, the additional tethered delay valid at the end of each measurement resolution period may be stored in a vector TetheredRTT. The unit of the RTT QoE metrics may be expressed in milliseconds.

Table 3 shows an example of the RTT QoE metric according to an embodiment of the present disclosure.

TABLE 3
16.2.6 Round-trip time
The round-trip time (RTT) consists of the RTP-level round-trip time,
plus the additional two-way delay (RTP
level−>loudspeaker−>microphone−>RTP level) due to buffering and other
processing in each client. For XRM applications, the round-trip time
(RTT) also includes the additional tethered delay due to the tethered
connection latency between tethered devices and the main UE client
(tethered device−>UE client).
The syntax for the metric “Round_Trip_Time” is defined in sub-clause
16.3.2.
The last RTCP round-trip time value estimated during each measurement
resolution period shall be stored in the vector NetworkRTT. The unit of
this metrics is expressed in milliseconds.
The two-way additional internal client delay valid at the end of each
measurement resolution period shall be stored in the vector InternalRTT.
The unit of this metrics is expressed in milliseconds.
The additional tethered delay valid at the end of each measurement
resolution period shall be stored in the vector TetheredRTT. The unit of
this metrics is expressed in milliseconds.
The three vectors are reported by the MTSI client as part of the QoE
report (sub-clause 16.4).
Note that if the RTP and the RTCP packets for a media are not sent in the
same RTP stream the estimated media round-trip time might be unreliable.

Embodiments of the present disclosure may define the codec QoE metric to include description information of 3D media, such as the V-PCC (video-based point cloud compression) codec defined by ISO/IEC 23090-5:2021.

For 3D media, the codec QoE metric may contain the 3D media codec type, represented as in an SDP offer, for instance, “VPCC.” In one embodiment, a semi-colon-separated video profile, and/or a profile level (and tier if applicable) may be reported, represented as in an SDP offer. In one embodiment, the maximum number of vertices, as well as maximum patch size, may also be reported, represented as “max_vertex=value” and “max_patch_length_x=value; max_patch_length_y=value,” respectively.

Table 4 shows an example of the codec QoE metric according to an embodiment of the present disclosure.

TABLE 4
16.2.8 Codec information
The codec information metrics contain details of the media codec settings
used in the receiving direction during the measurement resolution period.
If the codec information is changed during the measurement resolution
period, the codec information valid when each measurement resolution
period ends shall be reported. The unit of this metric is a string value. No
“white space” characters are allowed in the string values, and shall be
removed if necessary.
For speech media the semi-colon-separated codec information contains
the used speech codec type (represented as in an SDP rtpmap offer) and
the used codec settings for bandwidth and redundancy (represented as in
an SDP fmtp offer). For instance “EVS/16000/1;bw=swb;”, or
“EVS/16000/1;ch-aw-recv=3”.
For video media, the codec information contains the video codec type,
represented as in an SDP offer, for instance “H265/90000”. Furthermore,
the semi-colon-separated video profile, level (and tier if applicable) used
shall be reported, represented as in an SDP offer. For instance for H.265,
“profile-id=1;level-id=120;tier-flag-1”, or for H.264,
“profile-level-id=42e00a”.
The actually used image size (not the maximum allowed) shall also be
reported, represented as “WxH”, for example “320x240”.
For real-time text media, the codec information contains the text encoding,
represented as in an SDP offer, for instance “t140/1000/1”.
For 3D media, the codec information contains the 3D media codec type,
represented as in an SDP offer, for instance, “VPCC”. Furthermore, the
semi-colon-separated video profile, level, (and tier if applicable) used
shall be reported, represented as in an SDP offer. In addition, the
maximum number of vertices, as well as maximum patch size, shall also
be reported, represented as “max_vertex=value” and
“max_patch_length_x=value; max_patch_length_y=value”,
respectively.
The syntax for the metric “Codec_Info”, “Codec_ProfileLevel” and
“Codec_ImageSize” are defined in sub-clause 16.3.2.
The codec info, profile/level/tier and codec image size value for each
measurement resolution period shall be stored in the vectors CodecInfo,
CodecProfileLevel and CodecImageSize respectively. If the metric values
in these vectors for a measurement resolution period are unchanged from
the previous values in the respective vector, it is allowed to put the value
“=” in the vector to indicate this. The CodecInfo, CodecProfileLevel
and CodecImageSize vectors are reported by the MTSI client as part of the
QoE report (sub-clause 16.4).

Through the extended media metrics (e.g., at least one of the frame rate QoE metric, the RTT QoE metric, or the codec QoE metric) in the QoE report, the 5GS (e.g., the server) may parse the QoE report in order to identify the status of the UE 100, thereby allowing the MTSI sending entity (such as an MRF) to better assign resources to the MTSI session, or for the MTSI sending entity to initiate an SDP re-negotiation between the sender and receiver.

Table 5 shows an exemplary QoE metric reporting configuration in the QoE configuration according to an embodiment of the present disclosure, in particular the syntax and semantic for the “Sending-Rate.”

```
TABLE 5
16.3.2 QoE metric reporting configuration
The syntax of the text contained in the Metrics leaf is similar to the
“3GPP-QoE-Metrics” attribute syntax specified in TS 26.234 [60] and
TS 26.346 [74]:
  - att-measure-spec = Metrics “;” Sending-rate [“;” Measure-Range]
    [“;” Measure-Resolution] *([“;” Parameter-Ext])
The “Sending-Rate” shall be set, and it expresses the maximum time
period in seconds between two successive QoE reports. If the
“Sending-Rate” value is 0, then the client shall decide the sending time
of the reports depending on the events occurred in the client. When the
“Sending- Rate” value is 0, and the
“XRMEventTriggeredReports” reporting rule is set, the client shall send
QoE reports according to the events defined by the rule. Values ≥ 1
indicate a precise reporting interval. Then the value is ≥ 1 and the
“XRMEventTriggeredReports” reporting rule is set, the client shall send
QoE reports at the precise reporting interval, as well as according to the
events defined by the rule. The shortest interval is one second and the
longest interval is undefined. The reporting interval can be different for
different media, but it is recommended to maintain a degree of
synchronization in order to avoid extra traffic in the uplink direction. The
value “End” indicates that only one report is sent at the end of the session.
```

Embodiments of this disclosure may define that when the sending-rate value is 0, and when the QoE reporting rule definition as defined in Table 6 is set, the UE 100 may send one or more QoE reports according to the events defined by the QoE reporting rule. An embodiment defines that when the value is equal to or greater than 1, as well as when the QoE reporting rule is set, then the UE 100 may send one or more QoE reports at a reporting interval, as well as according to the events defined by the QoE reporting rule.

Table 6 shows an exemplary QoE reporting rule definition according to an embodiment of the present disclosure. Embodiments of this disclosure may define the QoE reporting rule for XRM services, named “XRMEventTriggeredReports.”

TABLE 6
16.3.3 QoE reporting rule definition
This clause defines the syntax and semantics of a set of rules which are
used to reduce the amount of reporting to the QoE metrics report server.
The syntax of the metrics reporting rules is defined below:
rule-name = ″OnlyCallerReports″ / ″LimitSessionInterval″ /
″SamplePercentage“ / “XRMEventTriggeredReports”
The XRMEventTriggeredReports rule is used to determine the events
which trigger the sending of a QoE metrics report within a session. When
this rule is present, haptic or interactivity events as signalled from a UE
application (such as XRM OpenXR application) will trigger the sending
of QoE reports. When this rule is present, all other rules are absent.

As defined by the semantic, the QoE reporting rule may be used to determine the events which trigger the sending of a QoE report within an MTSI session. When the QoE reporting rule is present, QoE reporting may be done by the UE 100, and the sending of one or more QoE reports may be triggered by haptic or interactive events as signalled from a UE application.

Table 7 shows an exemplary location filter element included in a QoE report according to an embodiment of the present disclosure.

TABLE 7
/<X>/<LocationFilter>
When present, this element indicates the geographic area(s) or location(s)
where quality metric collection is requested. When not present, quality
metric collection is requested regardless of the device's location. The
LocationFilter element comprises one or more instances of any
combination of targeted cell-IDs, polygons and circular areas. Each
cell-ID entry in LocationFilter is announced in cellList, and each polygon
and circular area entry is announced in the polygonList or and
circularAreaList elements, respectively.
- Occurrence: ZeroOrOne
- Format: node
- Minimum Access Types: Get
/<X>/<LocationFilter>/XRM
The XRM is a leaf where XRM use case specific location information can
be placed. This leaf specifics a list of XRM use cases/scenarios which
have different QoS/QoE requirements due to the location of the UE for
each use case/scenario.
- Occurrence: ZeroOrOne
- Format: node
- Minimum Access Types: Get

In one embodiment of the present disclosure, the location filter element may contain an “XRM” leaf. The “XRM” leaf may be defined such that XRM use case specific location information can be used to indicate where quality metric collection is requested. An example of such use case specific location is a differentiate of indoor and outdoor location of the UE 100, since XR media use cases are typically different in service requirements and characteristics according to the user's location (e.g., indoors, or outdoors). For indoors, the user may not move in a translational manner if seated. Whereas outdoors, the user may move a lot in a translational manner, especially if constantly moving, such as when walking, or on any form of transportation.

Embodiments of this disclosure may enable QoE reporting to support XRM, pose, haptics, 3D media, and/or audio for related real-time MTSI media services, through enhanced metrics. Embodiments of this disclosure may enable configuration and reporting rules for sending QoE reports based on XRM services.

The method according to the embodiment descried in the disclosure may be implemented in hardware, software, or a combination of hardware and software.

At least some of the example embodiment described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a field programmable gate array (FPGA) or application specific integrated circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the operations of any method or process so disclosed, may be combined in any combination, except combinations where at least some of such features and/or operations are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

While the disclosure has been shown and described with reference to various embodiments thereof, it will be understood by those skilled in the art that various changes in form and details may be made therein without departing from the scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a user equipment (UE) performing a quality of experience (QoE) reporting operation for extended reality (XR) media services, the method comprising:
receiving configuration information for a QoE reporting operation;
determining whether an event for the QoE reporting operation is triggered based on the configuration information;
generating a frame rate QoE metric comprising pose information of the UE;
in response to triggering the event, generating a QoE report comprising the frame rate QoE metric; and
transmitting the generated QoE report.

2. The method of claim 1, wherein the configuration information comprises at least one of a configuration of QoE metrics, a QoE metrics activation, or a QoE reporting rule.

3. The method of claim 1, wherein the pose information comprises a number of pose instances being measured by the UE based on the configuration information.

4. The method of claim 1, wherein the QoE report comprises:
a round-trip time (RTT) QoE metric comprising a tethered delay between at least one tethered device and the UE.

5. The method of claim 1, wherein the QoE report comprises:
a codec QoE metric comprising a 3D media codec type for 3D media.

6. The method of claim 5, wherein the codec QoE metric comprises:
at least one of a video profile or a profile level based on the 3D media codec type.

7. The method of claim 1, wherein the configuration information comprises a sending rate and an event-triggered reporting rule associated with the event.

8. The method of claim 7, wherein, when the sending rate is set to 0 and the event-triggered reporting rule is set, the UE sends the QoE report according to the event.

9. The method of claim 7, wherein, when the sending rate is set to a reporting time interval greater than 0 and the event-triggered reporting rule is set, the UE sends the QoE report at the reporting time interval.

10. The method of claim 1, wherein the QoE report comprises a location filter element indicating whether the UE is located in an indoor area or an outdoor area.

11. An apparatus of a user equipment (UE) performing a quality of experience (QoE) reporting operation for extended reality (XR) media services, the apparatus comprising:
a transceiver; and
a processor operably coupled with the transceiver, the processor configured to:
receive configuration information for a QoE reporting operation,
determine whether an event for the QoE reporting operation is triggered based on the configuration information,
generate a frame rate QoE metric comprising pose information of the UE,
in response to triggering the event, generate a QoE report comprising the frame rate QoE metric, and
transmit the generated QoE report.

12. The apparatus of claim 11, wherein the configuration information comprises at least one of a configuration of QoE metrics, a QoE metrics activation, or a QoE reporting rule.

13. The apparatus of claim 11, wherein the pose information comprises a number of pose instances being measured by the UE based on the configuration information.

14. The apparatus of claim 11, wherein the QoE report comprises:
a round-trip time (RTT) QoE metric comprising a tethered delay between at least one tethered device and the UE.

15. The apparatus of claim 11, wherein the QoE report comprises:
a codec QoE metric comprising a 3D media codec type for 3D media.

16. The apparatus of claim 15, wherein the codec QoE metric comprises:
at least one of a video profile or a profile level based on the 3D media codec type.

17. The apparatus of claim 11, wherein the configuration information comprises a sending rate and an event-triggered reporting rule associated with the event.

18. The apparatus of claim 17, wherein, when the sending rate is set to 0 and the event-triggered reporting rule is set, the UE sends the QoE report according to the event.

19. The apparatus of claim 17, wherein, when the sending rate is set to a reporting time interval greater than 0 and the event-triggered reporting rule is set, the UE sends the QoE report at the reporting time interval.

20. The apparatus of claim 11, wherein the QoE report comprises a location filter element indicating whether the UE is located in an indoor area or an outdoor area.
